(19) United States
(12) Patent Application Publication
(10) Pub. No.: US 2025/0293507 A1
(43) Pub. Date: Sep. 18, 2025

(54) OVERVOLTAGE PROTECTION SYSTEM

(71) Applicant: ERICO International Corporation, Solon, OH (US)

(72) Inventors: Greg Martinjak, Solon, OH (US); Dale Boling, Avon, OH (US); Ron Hotchkiss, Brooksville, FL (US); Christian Barcey, Streetsboro, OH (US)

(21) Appl. No.: 19/078,986

(22) Filed: Mar. 13, 2025

Related U.S. Application Data
(60) Provisional application No. 63/564,877, filed on Mar. 13, 2024.

(51) Int. Cl. H02H 3/20; H02H 3/05

(52) U.S. Cl. CPC H02H 3/20; H02H 3/05

(57) ABSTRACT

The disclosed technology provides an improved overvoltage protection system for an electrical system. An overvoltage protection system can include a first overvoltage circuit containing one or more metal oxide varistors (MOVs). A second overvoltage circuit can be connected in parallel with the first overvoltage circuit and can include one or more MOVs in series with one or more of a positive temperature coefficient (PTC) thermistor or a gas discharge tube (GDT).

### CROSS-REFERENCE TO RELATED APPLICATIONS

This application claims priority to and incorporates by reference U.S. provisional patent application No. 63/564,877, filed Mar. 13, 2024.

### BACKGROUND

Overvoltage protection can be used in different settings to minimize the effects of overvoltage events on electrical equipment. Transient overvoltage events may be associated with lightning or switching-induced surges that may exhibit relatively short durations. Without overvoltage protection, electrical equipment may be damaged or shut down during an overvoltage event. In particular, transient overvoltage protection can prevent electrical equipment from becoming damaged by transient overvoltage events.

### SUMMARY

The present disclosure relates to transient overvoltage protection technology and, in particular, to improved circuit assemblies and methods for discriminating between temporary over-voltage (TOV) and fast transient events.

In some aspects, the present disclosure can provide an overvoltage protection system for an electrical system. The overvoltage protection system can include a first overvoltage circuit connected between line and neutral of the electrical system, the line and ground of the electrical system, or the neutral and ground of the electrical system. The first overvoltage circuit can include two first metal oxide varistors (MOVs) in parallel. A second overvoltage circuit can be connected in parallel with the first overvoltage circuit between the one of the line and the neutral, the line and the ground, or the neutral and the ground of the electrical system. The second overvoltage circuit can include two second MOVs in parallel. The two second MOVs can be in series with a third MOV that can be in parallel with one or more of a positive temperature coefficient (PTC) thermistor or a second-circuit gas discharge tube.

In some examples, the overvoltage protection system can include a third overvoltage circuit. The third overvoltage circuit can be connected in parallel with the first and second overvoltage circuits between the one of the line and the neutral, the line and the ground, or the neutral and the ground of the electrical system. The third overvoltage circuit can include a capacitor configured to provide sine wave tracking for voltage signals to the electrical system.

In some examples, the first overvoltage circuit does not include a PTC thermistor and does not include a gas discharge tube.

In some examples, the two first MOVs can have a first clamping voltage. The two second MOVs can have a second clamping voltage. The second clamping voltage can be greater than the first clamping voltage.

In some examples, the overvoltage protection system can further include a communication module. The communication module can be arranged to detect a failure of the overvoltage protection system and can provide a corresponding alert to an operator. A controller of the overvoltage protection system can be configured to detect a failure of the first overvoltage circuit before a failure of the second overvoltage circuit. The controller can cause the communication module to provide the alert in response to the failure of the first overvoltage circuit.

In some aspects, the present disclosure can provide a method of protecting an electrical system from an overvoltage event. An overvoltage protection system can be provided. The overvoltage protection system can include a first voltage-responsive circuit, a second voltage-responsive circuit, and a frequency-responsive circuit, connected in parallel to the electrical system. The electrical system can be operated during the overvoltage event. A current caused by the overvoltage event can be directed through parallel first metal oxide varistors (MOVs) in the first voltage-responsive circuit. The current can further be directed through parallel second MOVs in the second voltage-responsive circuit and one or more parallel positive temperature coefficient (PTC) thermistors or parallel has discharge tubes (GDTs) in the second-voltage responsive circuit. Voltage spikes caused by the overvoltage event can be attenuated via one or more capacitor in the frequency-responsive circuit.

In some examples, a sine wave associated with one or more voltage signals within the electrical system can be tracked via the frequency-responsive circuit.

In some examples, a failure of the first voltage-responsive circuit can be detected prior to a failure of the second voltage-responsive circuit. An alert can be sent in response to the detected failure of the first voltage-responsive circuit via a communication module.

In some examples, the current can be directed, in the second voltage-responsive circuit, through the parallel MOVs in series with the one or more of the PTC thermistors or the GDTs.

In some examples, the first MOVs can provide a first clamping voltage. The second MOVs can provide a second clamping voltage. The second clamping voltage can be greater than the first clamping voltage.

In some examples, statuses associated with one or more of the first MOVs or the second MOVs can be determined. An end-of-life prediction for the overvoltage protection system can be outputted based on the statuses.

In some examples, the overvoltage event can be a low voltage event. A first portion of the current can be directed through the first voltage-responsive circuit. A second portion of the current can be directed through the second voltage-responsive circuit. The second portion can be less than the first portion.

In some aspects, the present disclosure can provide an overvoltage protection system for an electrical system. The overvoltage protection system can include a first voltage-responsive circuit connected between line and neutral, the line and ground, or the neutral and the ground of the electrical system. The first voltage-responsive circuit can include one or more first metal oxide varistors (MOVs). A second voltage-responsive circuit can be connected in parallel with the first voltage-responsive circuit between the line and the neutral, the line and the ground, or the neutral and the ground of the electrical system. The second voltage-responsive circuit can include one or more second MOVs in series with one or more of a positive temperature coefficient (PTC) thermistor or a gas discharge tube (GDT). A frequency-responsive circuit can be connected in parallel with the first and second voltage-responsive circuits between the line and the neutral, the lien and the ground, or the neutral and the ground of the electrical system. The frequency-responsive circuit can include one or more capacitors configured to provide sine wave tracking for voltage signals to the electrical system.

In some examples, one or more of the first or second voltage-responsive circuits can include multiple MOVs in parallel.

In some examples, the second voltage-responsive circuit can include the one or more second MOVs in series with a plurality of the one or more of the PTC thermistor or the GDT.

In some examples, the second voltage-responsive circuit includes the one or more second MOVs in series with a high pass filter. The high pass filter can include a third MOV, in parallel with the plurality of the one or more of the PTC thermistor or the GDT.

In some examples, the overvoltage protection system can further include a communication module. The communication module can be arranged to detect a failure of the overvoltage protection system and provide a corresponding alert to an operator.

In some examples, a controller of the overvoltage protection system can be configured to detect a failure of the first voltage-responsive circuit before a failure of the second voltage-responsive circuit. The controller can be configured to cause the communication module to provide the alert in responsive to the failure of the first voltage-responsive circuit.

In some examples, a controller of the overvoltage protection system can be configured to determine a plurality of statuses associated with each of the one or more first MOVs and the one or more second MOVs. The controller can be configured to output an end-of-life prediction of the first voltage-responsive circuit and the second voltage-responsive circuit via the communication module, based on the plurality of statuses.

### BRIEF DESCRIPTION OF THE DRAWINGS

The accompanying drawings, which are incorporated in and form a part of this specification, illustrate embodiments of the invention and, together with the description, serve to explain the principles of embodiments of the invention.

FIG. 1 is a schematic diagram of a transient overvoltage protection system according to the present disclosure.

FIG. 2 is a circuit diagram of an example configuration of the transient overvoltage protection system of FIG. 1.

FIG. 3 is a circuit diagram of another example transient overvoltage system according to the present disclosure.

### DETAILED DESCRIPTION

Before any examples of the disclosed technology are explained in detail, it is to be understood that the disclosed technology is not limited in its application to the details of construction and the arrangement of components set forth in the following description or illustrated in the following drawings. The disclosed technology is capable of other implementations and of being practiced or of being carried out in various ways. Also, it is to be understood that the phraseology and terminology used herein is for the purpose of description and should not be regarded as limiting.

The following discussion is presented to enable a person skilled in the art to make and use examples of the disclosed technology. Various modifications to the illustrated examples will be readily apparent to those skilled in the art, and the generic principles herein can be applied to other examples and applications without departing from the disclosed technology. Thus, the disclosed technology are not intended to be limited to examples shown, but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosed technology. Skilled artisans will recognize the examples provided herein have many useful alternatives that also fall within the scope of the disclosed technology.

As noted above, transient overvoltage protection technology can be used to minimize the effects of transient overvoltage events on electrical equipment. Generally, this type of technology includes a circuit or device which is placed between the line and neutral (or other) connections of an electrical system to selectively pass current between the connections. These circuits or devices can include a variety of components, including a combination of varistors and diodes.

Conventional designs for overvoltage protection technology may present various areas for improvement. For example, the components may be susceptible to failure or poor performance during TOV events, which may cause sustained 50 or 60 Hz over-voltage conditions to be applied to a circuit. TOV events can occur due to faults in a utility system, for example, rather than rapid transient events such as lightning strikes (e.g., exhibiting durations of 8 milliseconds (e.g., 0.5 cycles) to 1 or more minutes, as compared durations of 1 microsecond to hundreds of microseconds for transient events. In some examples, a TOV event may be caused by a loss of a neutral connection, a loss of a phase within an electrical system, poor voltage regulation, comingling of high voltage transmission and distribution lines, significant load changes to the system, or the like. In some examples, a TOV event may be caused by fault conditions within an electrical system, which cause temporary overvoltage conditions that originate from a medium voltage supply. In another example, a TOV event may be due to line to ground fault conditions for an ungrounded or impedance grounded delta-configured electrical system, in which an increase in voltage occurs on the other phases.

When TOV events occur, components within conventional transient overvoltage protection systems may attempt to clamp during every over-voltage oscillation. Due to the sustained nature of the TOV fault, the component may thus clamp excessively, causing the device to accumulate heat energy and fail. The failure of a component may leave the electrical equipment vulnerable to future over-voltage events until detected and replaced by a user.

Examples of the disclosed technology may provide an improved design for overvoltage protection technology, including for devices that can provide low clamping voltages and also discriminate between TOV events and high-frequency transient events, with corresponding increases in system lifespan. In particular, some examples can include arrangements that can provide primary overvoltage protection with relatively fast and low-magnitude clamping performance, along with secondary overvoltage protection that may exhibit more resilient operational characteristics (e.g., be less susceptible to damage from temporary over-voltage events). Accordingly, a combination of low clamping components and high clamping components may be used in some examples (e.g., arranged in parallel between the same two system connections). Low clamping components can provide a lower-voltage clamping value, for a higher level of system protection during high-frequency events, while high clamping components can provide more resiliency relative to TOV events (e.g., to provide back-up protection for transient overvoltage events).

Some examples of the disclosed technology can also address various issues associated with replacing components that are reaching end-of-life by providing a system to monitor the life remaining on the components within the technology. In some examples, the disclosed technology may track a number of components remaining in each circuit. For example, as described below, one or more circuits may include multiple metal oxide varistors (MOVs). Each MOV may have electrodes that allow the system to check continuity or voltage clamping functionality. Therefore, for example, the life remaining on the components may be determined by the proportion of functioning MOVs, or similar electrical components.

Generally, a transient overvoltage protection system may be used to protect an electrical system from electrical events (e.g., overvoltages), which may otherwise damage the components within the electrical system. In particular, examples herein may focus on the ability of a transient overvoltage protection system to discriminate between electrical events based on frequencies, although the disclosed principles may also be applicable to other types of electrical protection.

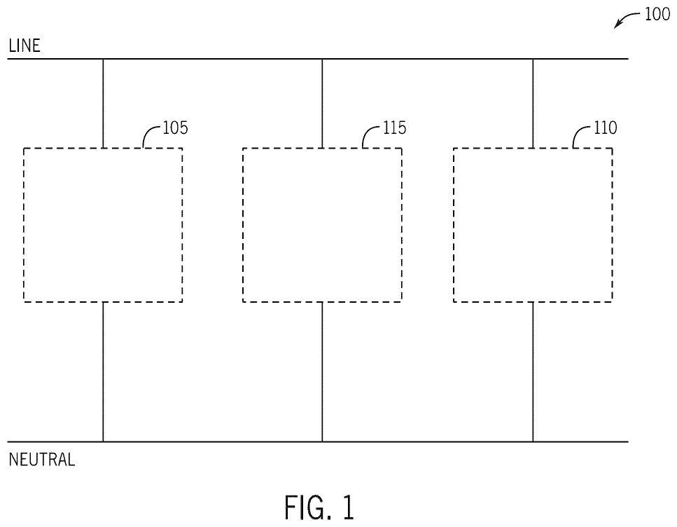

As one example, FIG. 1 illustrates a diagram of a transient overvoltage protection system 100. In the illustrated example, the transient overvoltage protection system 100 can include a first overvoltage circuit (or device) 105, a second overvoltage circuit (or device) 110, and third overvoltage circuit (or device) 115. As illustrated in FIG. 1, the first, second, and third overvoltage circuits 105, 110, 115 may be connected in parallel between line and neutral. In other examples, the first, second, and third overvoltage circuits 105, 110, 115 may be connected in parallel between line and ground, or between neutral and ground.

Although three overvoltage circuits (or devices) are illustrated in the example of FIG. 1, other configurations can have other numbers of circuits (or devices). For example, some configurations of the system 100 of FIG. 1 may include only the first and third overvoltage circuits 105, 115 or other sub-combinations. Generally, however, at least two circuits or devices can be connected in parallel to provide a combination of high performance and long operational lifespan, as discussed above and below.

The first, second, and third overvoltage circuits 105, 110, 115 may include various components. For example, MOVs, positive temperature coefficient (PTC) thermistors, gas discharge tubes (GDTs), gas tube arrestors (GTAs), inductors, capacitors, resistors, or other electrical components may be used. These components may be connected in parallel, in series, or a combination thereof within the relevant circuit 105, 110, 115. In some examples, the components may be selected based on their individual clamping voltages, to provide specific levels of protection and lifespans. For example, one (or more) of the circuits 105, 110, 115 may exhibit relatively low voltage clamping for improved system performance whereas another one (or more) of the circuits 105, 110, 115 may exhibit relatively high voltage clamping corresponding to improved durability (e.g., as used to provide a frequency-discriminating response, to pass transient overvoltage through the relevant overvoltage circuit). In such an arrangement, for example, the functionality of components with low voltage clamping may be impacted more by temporary overvoltage events than those with high voltage clamping. In some examples, components with low voltage clamping may disconnect prior to components with high voltage clamping during on an overvoltage event. Therefore, durability during overvoltage events may be achieved via the high voltage clamping components, in the event of the low voltage clamping components disconnecting.

In particular, in the illustrated example, the first overvoltage circuit 105 may be a voltage-responsive circuit that includes components with low clamping voltages. Thus, for example, the components included in the first overvoltage circuit 105 may prevent a connected electrical system from experiencing high voltages during a temporary overvoltage event, and the first overvoltage circuit 105 may operate as the primary means of protection for the connected electrical system. For example, during an overvoltage event, the first overvoltage circuit 105 may be the first circuit to respond, in particular, to low voltages and currents associated with the event. However, for other events, the distribution of current among the first, second, and third overvoltage circuits 105, 110, 115 may be different (e.g., become more equally distributed).

In contrast, the second (e.g., transient) overvoltage circuit 110 may be another voltage-responsive circuit that includes components with high clamping voltages. In particular, the second overvoltage circuit 110 may exhibit a higher clamping voltage than the first overvoltage circuit 105.

Further, in some examples, the high clamping components may provide discriminating functionality, allowing the second overvoltage circuit 110 to block voltages based on frequency. For example, the components included in the second overvoltage circuit 110 may prevent low frequency voltages from passing into a connected electrical system.

In this regard, in some examples, the low clamping components used in the first overvoltage circuit 105 may be more vulnerable to damage from lower frequency overvoltages, but also generally more protective of system components due to the relatively lower clamping voltage. Correspondingly, in the event of the first overvoltage circuit 105 failing, the second voltage circuit 110 may provide secondary or backup protection for a connected electrical system. Thus, for example, during initial service a relatively low clamping value can be provided by the first overvoltage circuit 105, with a correspondingly high level of protection for system components. Further, in the event of failure of the first overvoltage circuit 105, the more robust second overvoltage circuit 110 can take over protection against overvoltage events, albeit with a somewhat higher clamping voltage. Thus, for example, relatively high overall system protection can be achieved along with a high level of system durability (e.g., to ensure that protection is not completely lost between maintenance cycles, even in the event of failure of the first overvoltage circuit 110).

In some examples, the third overvoltage circuit 115 may be placed in parallel relative to the first overvoltage circuit 105 and the second overvoltage circuit 110. In particular, the third overvoltage circuit 115 may be a frequency-responsive circuit that include one or more voltage resisting electrical components (e.g., a capacitor) that can allow the third overvoltage circuit 110 may perform sine wave tracking in order to limit high frequency variations seen by a connected electrical system. Thus, for example, the third overvoltage circuit 115 may attenuate local spikes in voltage during an overvoltage event that may represent significant departures from normal voltage but may not necessarily exceed a clamping voltage level due to the location of the spikes along the curvature of the voltage sine wave. In this regard, the third overvoltage circuit 115 may be used simultaneously with one or both of the first overvoltage circuit 105 and the second overvoltage circuit 110.

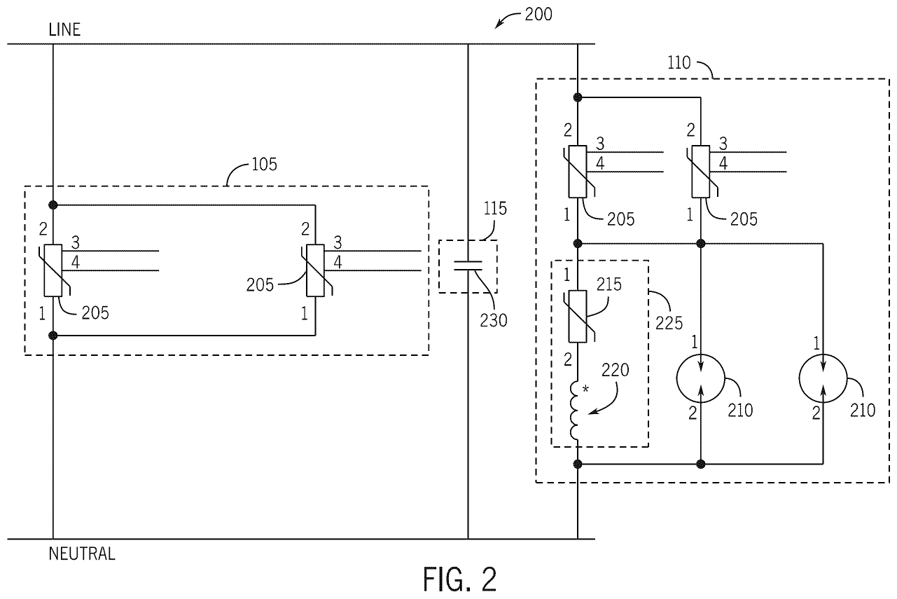

In different examples, different circuit components can be used for the various overvoltage circuits 105, 110, 115, including various protective components generally. As shown in FIG. 2, in particular, in a overvoltage protection system 200 that is a particular configuration of the system 100, the first overvoltage circuit 105 may include two or more MOVs 205 in parallel. The MOVs 205 may be a mechanical trip thermal-fused MOV, which combines a trip apparatus with an MOV. For example, when an overvoltage event occurs, the MOVs 205 of first overvoltage circuit 105 may offer a thermal disconnect performance, causing a trip apparatus to disconnect when triggered by a high voltage or temperature. In some examples, a diode, a GDT, a fuse, or a combination of components may be used in addition to an MOV. Generally, a PTC thermistor or a GDT may not be included in the first overvoltage circuit 105 with corresponding benefits for clamping performance (e.g., via increase in clamping voltage and corresponding increase in the standoff for this part of the overall system).

As illustrated in FIG. 2, the second overvoltage circuit 110 may include two or more MOVs 205 connected in series with two or more GDTs 210. Additionally, the second overvoltage circuit 110 may include a PTC thermistor 215 in series with an inductor 220 to create a high pass filter 225. In some examples, the inductor 220 may have an inductance of approximately 47 μH. The high pass filter 225 may allow high frequency transients to pass through the second overvoltage circuit 110 (e.g., for transients lasting only microseconds), while blocking low frequencies which may be caused by other overvoltage events.

Still referring to FIG. 2, in particular, the third overvoltage circuit 115 may include one or more capacitors 230 placed in parallel between the first overvoltage circuit 105 and the second overvoltage circuit 110. In some examples, the capacitor may have a capacitance of 2.2 μF. In other examples, the third overvoltage circuit 115 may have a capacitance ranging from 3.3 μF to 6.6 μF. Thus arranged, the third overvoltage circuit 115 may perform sine wave tracking on the voltage signals of the overvoltage protection system 200 as also generally discussed above.

Accordingly, as generally noted above, the first overvoltage circuit 105 can provide a primary overvoltage protection with a relatively low clamping value, and corresponding benefits for the protected system. Further, if the circuit 105 fails due to thermal overload as a result of sustained or repeated TOV events (or otherwise), the second overvoltage circuit 110 can provide backup overvoltage protection with, e.g., higher clamping voltage, along with the ability to discriminate between TOV and overvoltage events. Additionally, in some examples, the transient overvoltage circuit 105 can provide sine wave tracking, to further protect the relevant electronic systems.

In some examples, one or more of the overvoltage circuits 105, 110, 115 can be connected to a monitoring system that can predict, detect, or otherwise identify end-of-life (or other) events. Predictions or other alerts regarding end-of-life can be communicated accordingly with remote systems (e.g., to alert operators of potential failures in advance, or to alert operators of component failures to avoid larger loss of protection). Thus, some approaches disclosed herein can help to ensure appropriate scheduling of maintenance or other remedial actions. In this regard, for example, as a prediction of potential end-of-life, a monitoring system can identify that a lower-voltage clamping circuit has reached end-of-life and, correspondingly, that a parallel higher-voltage clamping circuit is providing overvoltage protection. In particular, some implementations can monitor how many of a set of MOVs remain active, and can provide a corresponding predictor of an end-of-life event (e.g., an indicator of a proportion or a count, of active or remaining MOVs for a particular one or more of the overvoltage circuits 105, 110). In some cases, the monitoring system can provide an alert accordingly, so that the lower-voltage (or other end-of-life) circuit can be replaced expediently. In other examples, other monitoring and alerts are also possible, with regard to various of the disclosed components, or other modes of potential failure.

In some examples, the first overvoltage circuit 105 (or the circuits 110, 115) may be in communication with a monitoring system configured to identify end-of-life events for one or more components of the circuit 105 (e.g., using various known approaches). In some examples, a thermal fuse or a thermally protected MOV may be used to indicate when one or more of the MOVs 205 reaches end-of-life. In this regard, for example, a thermally protected MOV can include a thermally activated disconnector mechanism (e.g., of various known types) or other similar circuit, generally referred to as a surge protection device (SPD) disconnector. An SPD disconnector can, for example, be arranged to interface with a monitoring circuit to report the status of the overall circuit

Such a monitoring system can, for example, be included on or in communication with a general purpose controller or other generally known types of control devices. Further, the monitoring system can include or be connected to a communications module (e.g., connected to a cellular modem or other known communication device via a general purpose or specialized controller). Thus, for example, the overall system can communicate information about the monitored overvoltage devices to appropriate other locations (e.g., centralized servers or remotely located control rooms/systems).

Thus, for example, some configurations can track the remaining life of the MOVs 205 within the transient overvoltage protection system 200 (or other system components), or may be otherwise configured to determine that the MOVs 205 (or other components) have reached or may soon reach end-of-life. In some examples, a ratio or percentage of life remaining for the corresponding MOVs 205 (or other components) can be determined and relayed to other (e.g., external) systems. In some examples, when one or more of the MOVs 205 reaches end-of-life, an LED may illuminate to notify a user, or another type of alert can be provided.

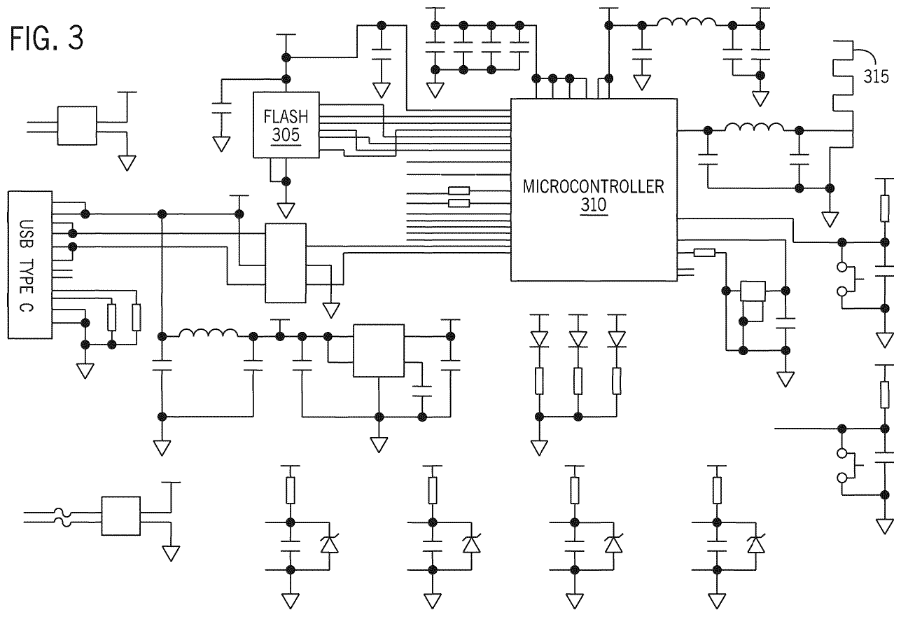

In some embodiments, a transient overvoltage protection system may be integrated into a larger electrical system. FIG. 3 illustrates an example circuit diagram of a transient overvoltage protection system within an electrical system 300. The electrical system 300 may include a flash memory 305 and a microcontroller 310. In some examples, the overvoltage circuits 105, 110, 115 may include one or more monitoring pins, which may be connected to the microcontroller 310. The microcontroller 310 may be configured to detect a failure of the first overvoltage circuit 105. In some examples, when the microcontroller 310 detects a failure of the first overvoltage circuit 105, it may direct a communication module (e.g., including an antenna 315) to alert a user. Accordingly, for example, operators may be able to reliably conduct appropriate maintenance (e.g., replace the circuit 105) before a failure occurs on the second overvoltage circuit 110.

In some examples, a communication module may include or be configured to provide indicators for particular components within the transient overvoltage protection system 100 (or 200), which may indicate to a user when a particular component is reaching end-of-life. In some examples, the communication module may also provide an alert corresponding to a detected failure of a particular circuit (e.g., the first, second, or third overvoltage circuits 105, 110, 115).

The use herein of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Unless otherwise specified or limited, the terms “about” and “approximately,” as used herein with respect to a reference value, refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of less than ±5% (e.g., ±2%, ±1%, ±0.5%) inclusive. Where specified in particular, “substantially” can indicate a variation in one numerical direction relative to a reference value. For example, the term “substantially less” than a reference value (and the like) indicates a value that is reduced from the reference value by 30% or more (e.g., 35%, 40%, 50%, 65%, 80%), and the term “substantially more” than a reference value (and the like) indicates a value that is increased from the reference value by 30% or more (e.g., 35%, 40%, 50%, 65%, 80%).

As used herein, unless otherwise specified, ordinal numbers are used for convenience to differentiate between systems, components, etc. based on the order of introduction into the relevant text. Correspondingly, unless otherwise specified, ordinal numbers are not intended to indicate a particular sequential order, priority, or other limitation.

The previous description of the disclosed examples is provided to enable any person skilled in the art to make or use the disclosed technology. Various modifications to these examples will be readily apparent to those skilled in the art, and the generic principles defined herein may be applied to other examples without departing from the spirit or scope of the disclosed technology. Thus, the disclosed technology is not intended to be limited to the examples shown herein but is to be accorded the widest scope consistent with the principles and novel features disclosed herein.

1. An overvoltage protection system for an electrical system, the overvoltage protection system comprising:
a first overvoltage circuit connected between line and neutral of the electrical system, the line and ground of the electrical system, or the neutral and the ground of the electrical system, the first overvoltage circuit including two first metal oxide varistors (MOVs) in parallel; and
a second overvoltage circuit connected in parallel with the first overvoltage circuit between the one of the line and the neutral of the electrical system, the line and the ground of the electrical system, or the neutral and the ground of the electrical system, the second overvoltage circuit including two second MOVs in parallel, the two second MOVs being in series with a third MOV that is in parallel with one or more of a positive temperature coefficient (PTC) thermistor or a second-circuit gas discharge tube.

2. The overvoltage protection system of claim 1, further comprising:
a third overvoltage circuit connected in parallel with the first and second overvoltage circuits between the one of the line and the neutral of the electrical system, the line and the ground of the electrical system, or the neutral and the ground of the electrical system, the third overvoltage circuit including a capacitor configured to provide sine wave tracking for voltage signals to the electrical system.

3. The overvoltage protection system of claim 1, wherein the first overvoltage circuit does not include a PTC thermistor and does not include a gas discharge tube.

4. The overvoltage protection system of claim 1, wherein:
the two first MOVs have a first clamping voltage, and
the two second MOVs have a second clamping voltage, the second clamping voltage being greater than the first clamping voltage.

5. The overvoltage protection system of claim 1, further comprising:
a communication module arranged to detect a failure of the overvoltage protection system and provide a corresponding alert to an operator;
wherein a controller of the overvoltage protection system is configured to detect a failure of the first overvoltage circuit before a failure of the second overvoltage circuit and to cause the communication module to provide the alert in response to the failure of the first overvoltage circuit.

6. A method of protecting an electrical system from an overvoltage event, the method comprising:
providing an overvoltage protection system that includes a first voltage-responsive circuit, a second voltage-responsive circuit, and a frequency-responsive circuit, connected in parallel to the electrical system;
operating the electrical system during the overvoltage event, including to:
direct a current caused by the overvoltage event through parallel first metal oxide varistors (MOVs) in the first voltage-responsive circuit, and through parallel second MOVs in the second voltage-responsive circuit and one or more of parallel positive temperature coefficient (PTC) thermistors or parallel gas discharge tubes (GDTs) in the second voltage-responsive circuit; and
attenuating voltage spikes caused by the overvoltage event via one or more capacitors in the frequency-responsive circuit.

7. The method of claim 6, further comprising:
tracking, via the frequency-responsive circuit, a sine wave associated with one or more voltage signals within the electrical system.

8. The method of claim 6, further comprising:
detecting a failure of the first voltage-responsive circuit prior to a failure of the second voltage-responsive circuit; and
sending an alert, via a communication module, in response to the detected failure of the first voltage-responsive circuit.

9. The method of claim 6, wherein the current is directed, in the second voltage-responsive circuit, through the parallel MOVs in series with the one or more of the PTC thermistors or the GDTs.

10. The method of claim 9, wherein the current is directed, in the second voltage-responsive circuit, through a high pass filter in parallel with the one or more of the PTC thermistors or the GDTs.

11. The method of claim 6, wherein:
the first MOVs provide a first clamping voltage, and
the second MOVs provide a second clamping voltage, the second clamping voltage being greater than the first clamping voltage.

12. The method of claim 6, further comprising:
determining statuses associated with one or more of the first MOVs or the second MOVs; and
outputting an end-of-life prediction for the overvoltage protection system based on the statuses.

13. The method of claim 6, wherein, with the overvoltage event being a low voltage event:
a first portion of the current is directed through the first voltage-responsive circuit; and
a second portion of the current is directed through the second voltage-responsive circuit, the second portion being less than the first portion.

14. An overvoltage protection system for an electrical system, the overvoltage protection system comprising:
a first voltage-responsive circuit connected between line and neutral of the electrical system, the line and ground of the electrical system, or the neutral and the ground of the electrical system, the first voltage-responsive circuit including one or more first metal oxide varistors (MOVs);
a second voltage-responsive circuit connected in parallel with the first voltage-responsive circuit between the line and the neutral of the electrical system, the line and the ground of the electrical system, or the neutral and the ground of the electrical system, the second voltage-responsive circuit including one or more second MOVs in series with one or more of a positive temperature coefficient (PTC) thermistor or a gas discharge tube (GDT); and
a frequency-responsive circuit connected in parallel with the first and second voltage-responsive circuits between the line and the neutral of the electrical system, the line and the ground of the electrical system, or the neutral and the ground of the electrical system, the frequency-responsive circuit including one or more capacitors configured to provide sine wave tracking for voltage signals to the electrical system.

15. The overvoltage protection system of claim 14, wherein one or more of the first or second voltage-responsive circuits includes multiple MOVs in parallel.

16. The overvoltage protection system of claim 15, wherein the second voltage-responsive circuit includes the one or more second MOVs in series with a plurality of the one or more of the PTC thermistor or the GDT.

17. The overvoltage protection system of claim 16, wherein the second voltage-responsive circuit includes the one or more second MOVs in series with a high pass filter that includes a third MOV, in parallel with the plurality of the one or more of the PTC thermistor or the GDT.

18. The overvoltage protection system of claim 14, further comprising:
a communication module arranged to detect a failure of the overvoltage protection system and provide a corresponding alert to an operator.

19. The overvoltage protection system of claim 18, wherein a controller of the overvoltage protection system is configured to:
detect a failure of the first voltage-responsive circuit before a failure of the second voltage-responsive circuit; and
cause the communication module to provide the alert in response to the failure of the first voltage-responsive circuit.

20. The overvoltage protection system of claim 18, wherein a controller of the overvoltage protection system is configured to:
determine a plurality of statuses associated with each of the one or more first MOVs and the one or more second MOVs; and
outputting, via the communication module, an end-of-life prediction of the first voltage-responsive circuit and the second voltage-responsive circuit based on the plurality of statuses.
